(19) United States
(12) Patent Application Publication
(10) Pub. No.: US 2012/0143943 A1
(43) Pub. Date: Jun. 7, 2012

(54) CLOUD SERVICE SYSTEM AND METHOD, AND RECORDING MEDIUM

(76) Inventors: Kai-Liang KO, Kaohsiung City (TW); Jia-Ren Wang, Kaohsiung County (TW); Shih-Ming Huang, Kaohsiung County (TW)

(21) Appl. No.: 13/105,319

(22) Filed: May 11, 2011

(30) Foreign Application Priority Data
Dec. 3, 2010 (TW) 099142197

(51) Int. Cl. G06F 15/16

(52) U.S. Cl. 709/203

(57) ABSTRACT

A cloud service system includes a server and a first cloud service platform. The server stores a service program. The first cloud service platform is in communication with the server and includes a first service index, a first communication control processing module, a first temporary data storage module and a first registration module. When a client device requests the first cloud service platform for a service, the first communication control processing module determines whether the first temporary data storage module stores the service program, and if the first temporary data storage module does not store the service program, the first communication control processing module obtains the service program from the server by using a first link path preset in the first service index, executes the service program obtained from the server for providing a cloud service to the client device, and stores the service program into the first temporary data storage module.

### CROSS-REFERENCE TO RELATED APPLICATION

This application claims the benefit of Taiwan Patent Application No. 099142197, filed on Dec. 3, 2010, which is hereby incorporated by reference for all purposes as if fully set forth herein.

### BACKGROUND OF THE INVENTION

1. Field of Invention

The present invention relates to a cloud service system, and more particularly to a cloud service system and method, and recording medium applicable to a wireless communication device.

2. Related Art

With the rapid development of information technology, the concept of cloud technology has been increasingly accepted. The cloud technology means that a client device (for example, a computer, mobile phone, satellite navigation device or even an auto teller machine) is capable of being linked to a cloud service platform through the Internet, and inputting relevant information such as a personal account or password to request the cloud service platform for a service program, after which the cloud service platform provides the service program dedicated to the client device for using.

FIG. 1A is a schematic view of a conventional cloud service system; and FIG. 1B is a schematic view illustrating that a client device in FIG. 1A intends to obtain a service program after arriving at another place.

As shown in FIG. 1A, the cloud service system 50 includes a first cloud service platform 501, a client device 500 is capable of being linked to the first cloud service platform 501 through the Internet at a first place P1 (for example, America) and inputting relevant information such as a personal account or password to request the first cloud service platform 501 for a service program 502, and after the first cloud service platform 501 determines that the relevant information is correct, the first cloud service platform 501 obtains the service program 502 dedicated to the client device 500 from a first server 503, and provides the service program 502 to the client device 500.

As shown in FIG. 1B, when the client device 500 is located at a second place P2 (for example, Asia) and intends to obtain the service program 502 again, the client device 500 is linked to a second cloud service platform 504 of the cloud service system 50 through the Internet to try to obtain the service program 502 from a second server 505 of the second cloud service platform 504. If the second server 505 of the second cloud service platform 504 does not store the service program 502, the client device 500 has to be linked from the second place P2 to the distant first cloud service platform 501 through the Internet so as to obtain the service program 502 again from the first server 503.

It can be seen that, such a network-based cloud technology has the following problems. Each time when it is intended to obtain the service program 502, the client device 500 needs to be linked back to the cloud service platform 501 of the first place P1 through the Internet so as to obtain the service program 502 again, and therefore, the network-based cloud technology is time-consuming and has a low service efficiency for the client device 500.

Especially when the client device is a mobile phone connected to the cloud service system through a telecommunication network to obtain a network service, the communication cost is increased due to the time-consuming connection, and the service demanded by the client device cannot be easily provided in real time due to low efficiency.

To solve the above problems, a cache-based cloud technology has been developed in the prior art. FIG. 2A is a schematic view of a conventional cloud service system; and FIG. 2B is a schematic view illustrating that a client device in FIG. 2A intends to obtain a service program at another place.

As shown in FIG. 2A, the cloud service system 60 includes a first cloud service platform 601. Likewise, a client device 600 is capable of being linked to the first cloud service platform 601 through the Internet at a first place P1 (for example, America) and inputting relevant information such as a personal account or password to request the first cloud service platform 601 for a service program 602. After the first cloud service platform 601 determines that the relevant information is correct, the first cloud service platform 601 obtains the service program 602 dedicated to the client device 600 from a first server 603, and provides the service program 602 to the client device 600.

As shown in FIG. 2B, when the client device 600 is located at a second place P2 (for example, Asia), the client device 600 is linked to a second cloud service platform 604 of the cloud service system 60 through the Internet to directly obtain the service program 602 from a second server 605 of the second cloud service platform 604.

It can be seen that, such a cache-based cloud technology has the following problems. Cloud system providers must deploy the service program 602 on every cloud service platform (for example, the first cloud service platform 601 and the second cloud service platform 604), so as to allow the client device 600 to use the service program 602 at different places (for example, the first place P1 and the second place P2). It means that, all the cloud system providers must repeatedly set up the service program 602, and the unnecessary resource waste will be resulted.

### SUMMARY OF THE INVENTION

Accordingly, the present invention provides a cloud service system, method and recording medium, so as to solve the above problems of time-consuming for connection in the network-based cloud service system and of resource waste in the cache-based cloud service system for setting up all the services repeatedly.

To achieve the above objectives, the present invention provides a cloud service system, which comprises a server and a first cloud service platform. The server stores a service program. The first cloud service platform is in communication with the server and comprises a first service index, a first communication control processing module, a first temporary data storage module and a first registration module. When a client device sends a service request message to the first cloud service platform, the first communication control processing module determines whether the first temporary data storage module stores the service program. If the first temporary data storage module does not store the service program, the first communication control processing module obtains the service program from the server by using a first link path preset in the first service index, executes the service program obtained from the server for providing a cloud service to the client device, and stores the service program corresponding to the cloud service used by the client device into the first temporary data storage module.

To achieve the above objectives, the present invention further provides a cloud service method, applicable to a cloud service system comprising a server and a first cloud service platform. The first cloud service platform is in communication with the server and comprises a first service index, a first communication control processing module, a first temporary data storage module and a first registration module. The cloud service method comprises: storing a service program in the server; receiving a service request message sent from a client device by the first cloud service platform; determining whether the first temporary data storage module stores the service program by the first communication control processing module; if the first temporary data storage module does not store the service program, obtaining the service program from the server by using a first link path preset in the first service index by the first communication control processing module; executing the service program obtained from the server for providing a cloud service to the client device by the first communication control processing module; and storing the service program corresponding to the cloud service used by the client device into the first temporary data storage module by the first communication control processing module.

To achieve the above objectives, the present invention further provides a computer readable recording medium, for storing a computer program, and applicable to a cloud service system comprising a server and a first cloud service platform. The first cloud service platform is in communication with the server and comprises a first service index, a first communication control processing module, a first temporary data storage module and a first registration module, and when the computer program is executed by the cloud service system, a cloud service method is completed. The cloud service method comprises: storing a service program in the server; receiving a service request message sent from a client device by the first cloud service platform; determining whether the first temporary data storage module stores the service program by the first communication control processing module; if the first temporary data storage module does not store the service program, obtaining the service program from the server by using a first link path preset in the first service index by the first communication control processing module; executing the service program obtained from the server for providing a cloud service to the client device by the first communication control processing module; and storing the service program corresponding to the cloud service used by the client device into the first temporary data storage module by the first communication control processing module.

The cloud service system, method and recording medium provided by the embodiments of the present invention have the following advantages.

The service program corresponding to the cloud service used by the client device is stored in the temporary data storage module, so that each cloud service platform can record a service program position message of the service program used by the client device, and learn about which cloud service platform the service program used by the client device is currently stored in, so as to enable the client device at any place to use an adjacent cloud service platform to continue using the service program.

### BRIEF DESCRIPTION OF THE DRAWINGS

The present invention will become more fully understood from the detailed description given herein below for illustration only, and thus are not limitative of the present invention, and wherein:

FIG. 1A is a schematic view of a conventional cloud service system;

FIG. 1B is a schematic view illustrating that a client device in FIG. 1A intends to obtain a service program after arriving at another place;

FIG. 2A is a schematic view of a conventional cloud service system;

FIG. 2B is a schematic view illustrating that a client device in FIG. 2A intends to obtain a service program after arriving at another place;

FIG. 3A is a schematic view of a cloud service system according to an embodiment of the present invention;

FIG. 3B is a schematic view of providing a service program to a client device by the cloud service system through a first cloud service platform;

FIG. 3C is a schematic view of providing a service program to a client device by the cloud service system through a second cloud service platform;

FIG. 3D is a schematic view of providing a service program to a client device by the cloud service system through a third cloud service platform;

FIG. 4A is a flow chart of a cloud service method according to an embodiment of the present invention;

FIG. 4B is a flow chart of the cloud service method for obtaining a service through a second cloud service platform according to an embodiment of the present invention; and

FIG. 4C is a flow chart of the cloud service method for obtaining a service through a third cloud service platform according to an embodiment of the present invention.

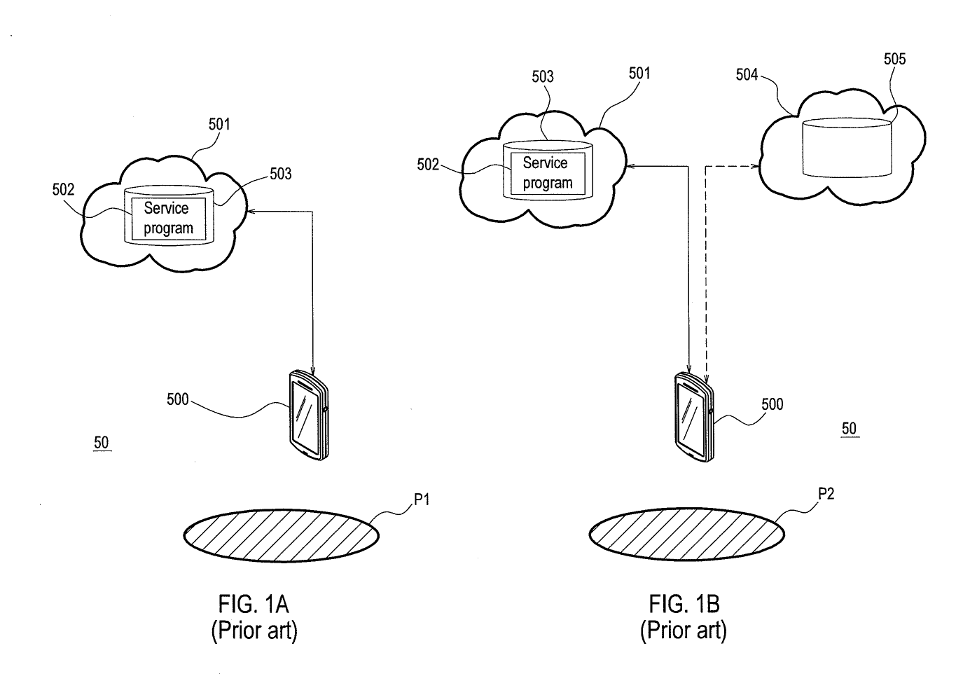

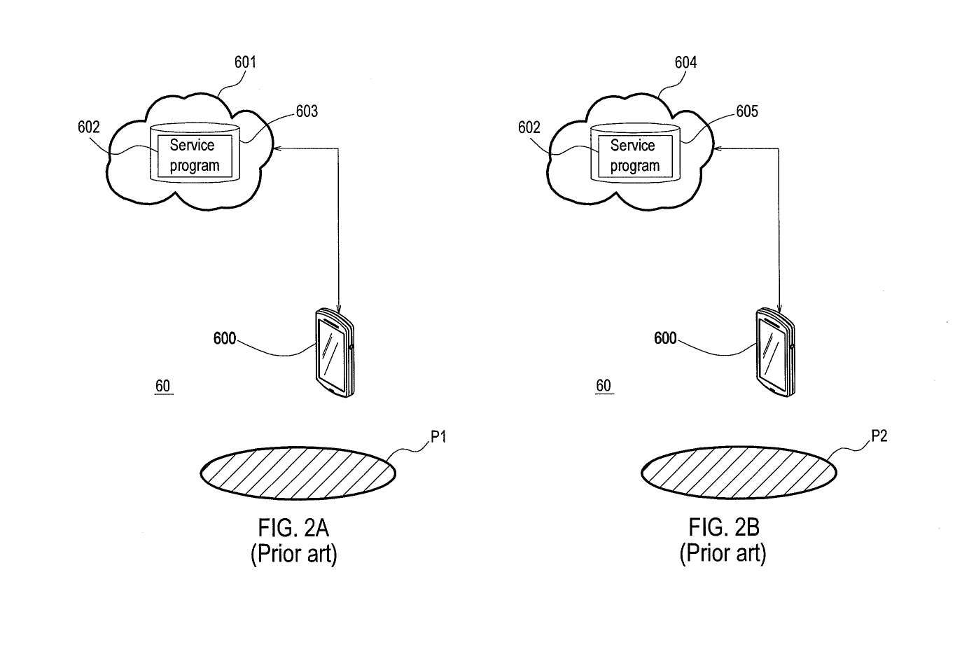

### DETAILED DESCRIPTION OF THE INVENTION

In order to make the abovementioned objectives, features, and advantages of the present invention comprehensible, relevant embodiments of the present invention are described in detail below with reference to the accompanying drawings.

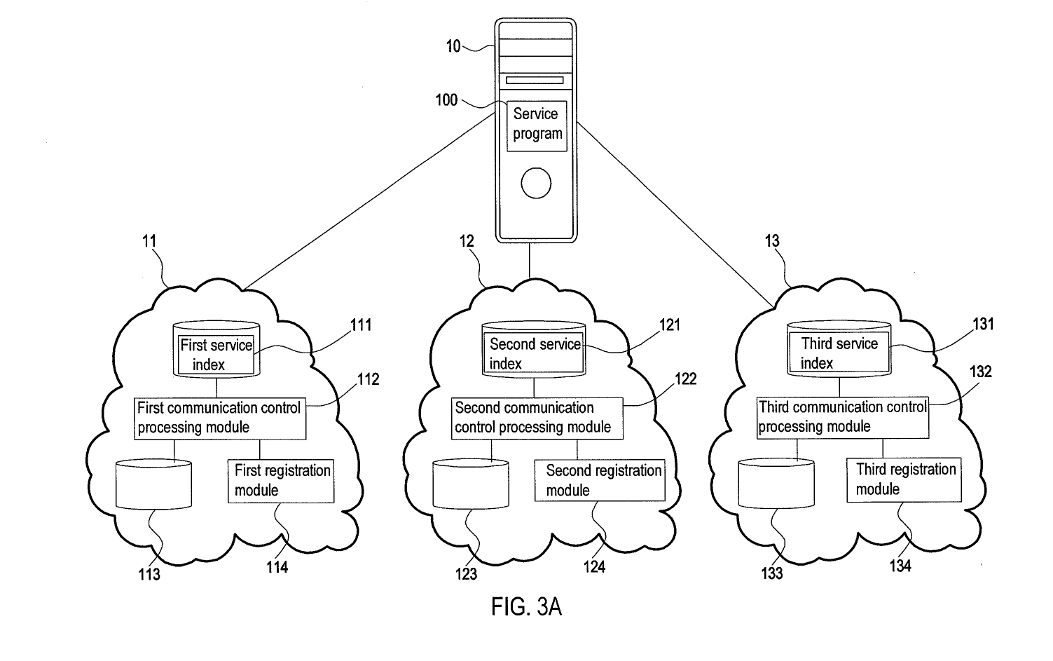

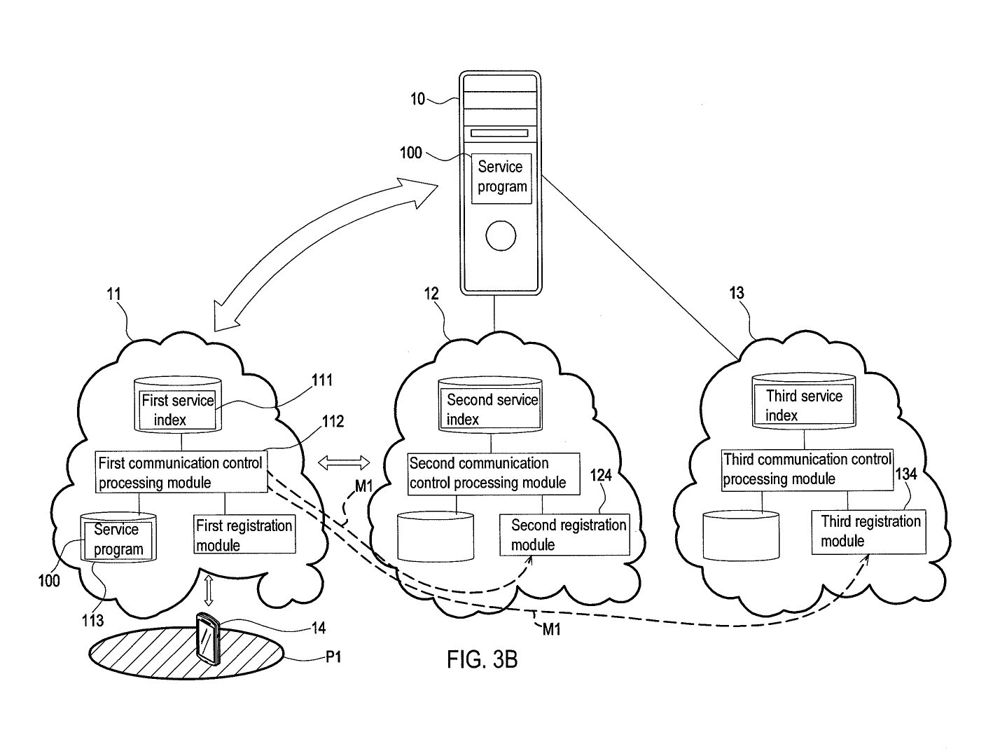

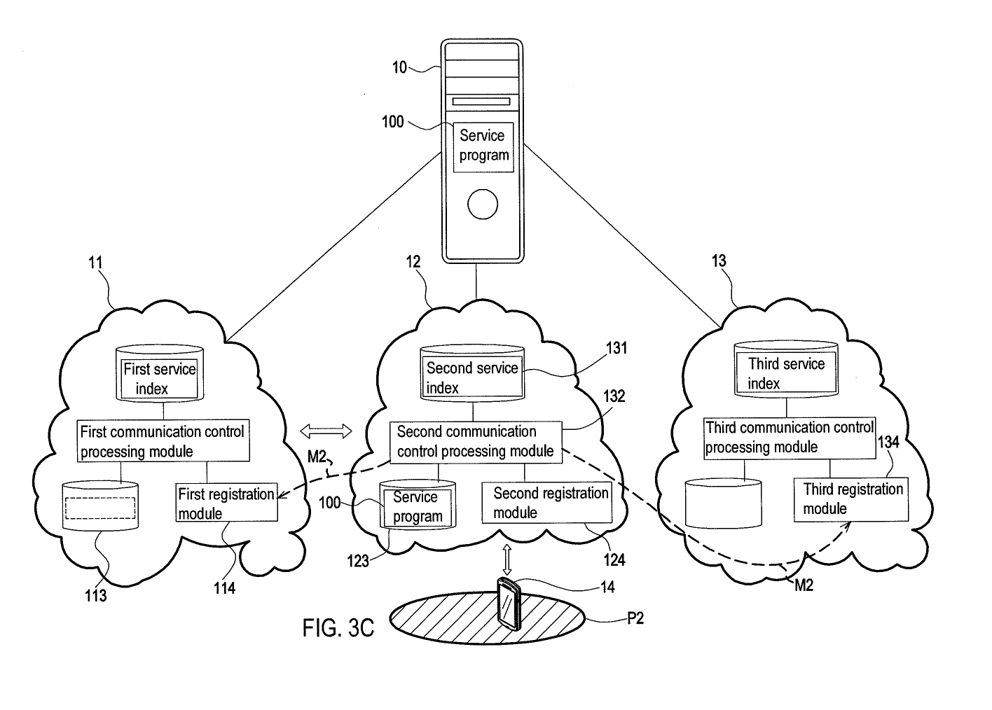

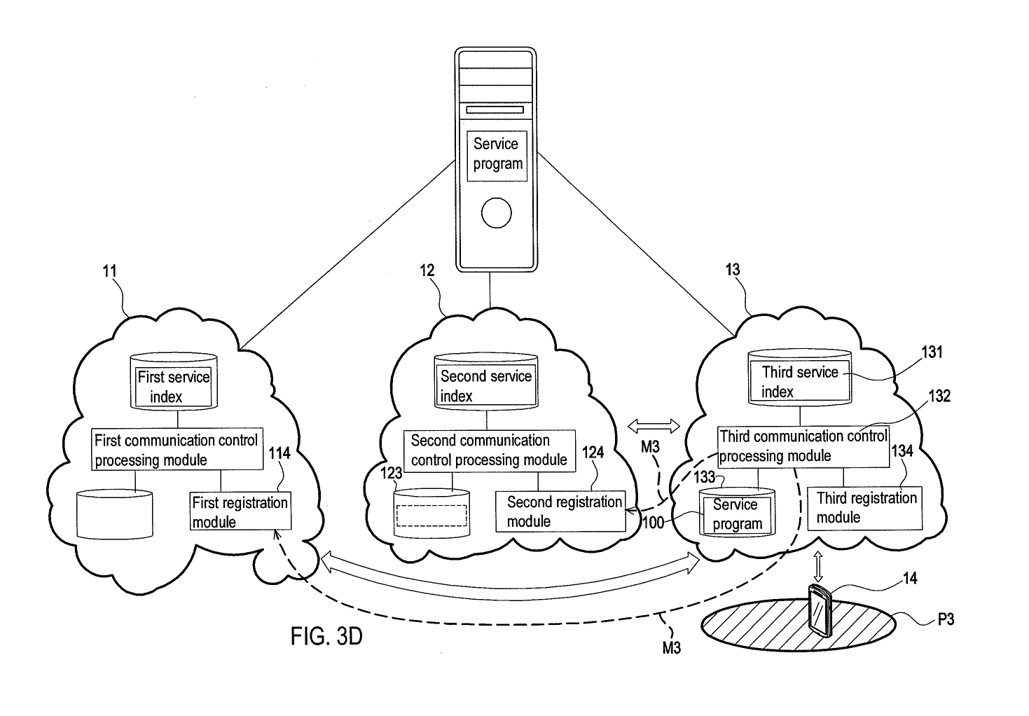

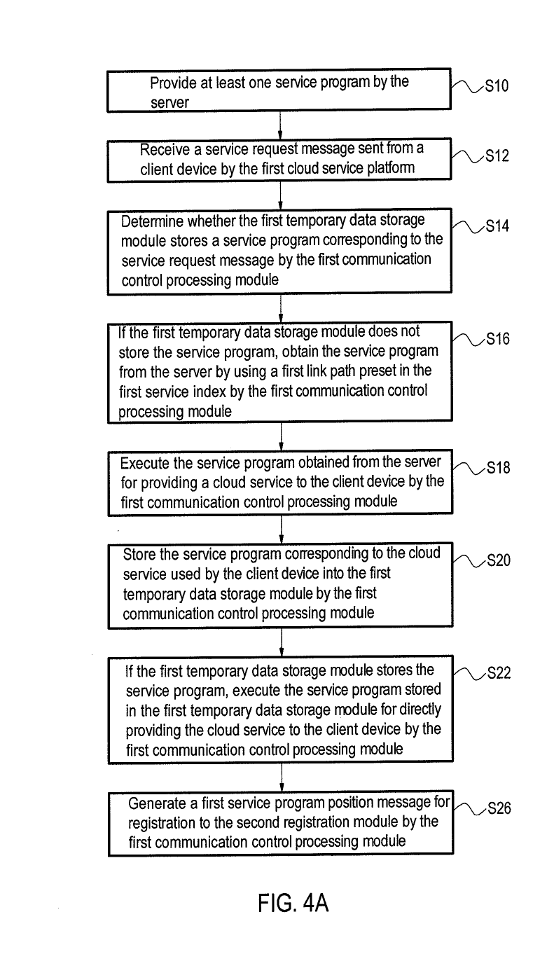

FIG. 3A is a schematic view of a cloud service system according to an embodiment of the present invention.

As shown in FIG. 3A, the cloud service system includes a server 10 and at least one cloud service platform. The at least one cloud service platform includes a first cloud service platform 11. For convenience of description of the service mode of the cloud service system of the present invention, in this embodiment, the cloud service system further includes a second cloud service platform 12 and a third cloud service platform 13.

The server 10 stores a service program 100. The service program 100 includes software or operating system services for use by a client device. In another embodiment, the client device 14 may be a mobile phone (as shown in FIG. 3B) capable of being linked to the at least one cloud service platform through a telecommunication network, and the first cloud service platform 11 is a cloud service platform adjacent to the client device 14 among the at least one cloud service platform. Preferably, the client device 14 is the cloud service platform nearest to the client device 14 among the first cloud service platform 11.

The first cloud service platform 11 includes a first service index 111, a first communication control processing module 112, a first temporary data storage module 113 and a first registration module 114. The second cloud service platform 12 includes a second service index 121, a second communication control processing module 122, a second temporary data storage module 123 and a second registration module 124. The third cloud service platform 13 includes a third service index 131, a third communication control processing module 132, a third temporary data storage module 133 and a third registration module 134.

The server 10, the first cloud service platform 11, the second cloud service platform 12 and the third cloud service platform 13 are capable of communication with each other, for example, the server 10, the first cloud service platform 11, the second cloud service platform 12 and the third cloud service platform 13 are in communication with each other through a wired Internet or telecommunication network. Alternatively, the server 10, the first cloud service platform 11, the second cloud service platform 12 and the third cloud service platform 13 are in communication with each other through a wireless Internet, but the present invention is not limited thereto.

In addition, the first service index 111, the second service index 121 and the third service index 131 respectively record link paths of the service program 100 respectively preset by the system provider. In another embodiment, the service indexes 111, 121 and 131 may respectively record link paths of different service programs to be provided.

FIG. 3B is a schematic view of providing a service program to a client device by the cloud service system through a first cloud service platform.

As shown in FIG. 3B, the first cloud service platform 11 is in communication with the server 10, and the second cloud service platform 12 is in communication with the first cloud service platform 11.

When the client device 14 is located at a first place P1 (for example, America) and intends to obtain a service (for example, obtain the service program 100), the client device 14 sends a service request message to the first cloud service platform 11. At this time, the first communication control processing module 112 determines whether the first temporary data storage module 113 stores the service program 100 corresponding to the service request message sent from the client device 14 (in this embodiment, the case that the first temporary data storage module 113 does not store the corresponding service program is described first). If the first temporary data storage module 113 does not store the service program 100, the first communication control processing module 112 obtains the service program 100 from the server 10 by using a first link path preset in the first service index 111.

The first communication control processing module 112 executes the service program 100 obtained from the server 10 for providing a cloud service to the client device 14, stores the service program 100 corresponding to the cloud service used by the client device 14 into the first temporary data storage module 113, and generates a first service program position message M1, which may be registered to the second registration module 124 and/or the third registration module 134 to notify the second cloud service platform 12 and the third cloud service platform 13 that the first temporary data storage module 113 currently stores the service program 100 corresponding to the cloud service used by the client device 14.

In addition, the first communication control processing module 112 has stored the service program 100 corresponding to the cloud service used by the client device 14 into the first temporary data storage module 113 last time. When the client device 14 is still located at the first place P1 and intends to use the cloud service next time, the first communication control processing module 112 determines that the first temporary data storage module 113 stores the service program 100, executes the service program 100 stored in the first temporary data storage module 113 for directly providing the cloud service to the client device 14, and stores the service program 100 corresponding to the cloud service used by the client device 14 into the first temporary data storage module 113. The first communication control processing module 112 generates the first service program position message M1 for registration to the second registration module 124 and/or the third registration module 134 to notify the second cloud service platform 12 and/or the third cloud service platform 13 that the first temporary data storage module 113 currently stores the service program 100 corresponding to the cloud service used by the client device 14.

In addition, the client device 14 may also be implemented by a notebook computer, an e-book or a personal digital assistant (PDA), but is not limited to the mobile phone in this embodiment.

FIG. 3C is a schematic view of providing a service program to a client device by the cloud service system through a second cloud service platform.

As shown in FIG. 3C, when the client device 14 is located at a second place P2 (for example, Europe) and intends to obtain the service (for example, obtain the service program 100), the client device 14 sends the service request message to the second cloud service platform 12. The second service index 121 generates a second link path according to the first service program position message M1 of the second registration module 124. The second communication control processing module 122 obtains the service program 100 corresponding to the cloud service used by the client device 14 last time from the first temporary data storage module 113 by using the second link path provided by the second service index 121, executes the service program 100 obtained from the first temporary data storage module 113 for directly providing the cloud service to the client device 14, stores the service program 100 into the second temporary data storage module 123, and generates a second service program position message M2 for registration to the first registration module 114 and/or the third registration module 134 to notify the first cloud service platform 11 and/or the third cloud service platform 13 that the second temporary data storage module 123 currently stores the service program 100.

FIG. 3D is a schematic view of providing a service program to a client device by the cloud service system through a third cloud service platform.

As shown in FIG. 3D, the third cloud service platform 13 is in communication with the first cloud service platform 11 and the second cloud service platform 12. When the client device 14 is located at a third place P3 (for example, Asia) and intends to obtain the service (for example, obtain the service program 100), the client device 14 sends the service request message to the third cloud service platform 13, the third service index 131 generates a third link path according to the second service program position message M2 of the third registration module 134. The third communication control processing module 132 obtains the service program 100 corresponding to the cloud service used by the client device 14 last time from the second temporary data storage module 123 by using the third link path provided by the third service index 131, executes the service program 100 obtained from the second temporary data storage module 123 for directly providing the cloud service to the client device 14, stores the service program 100 into the third temporary data storage module 133, and generates a third service program position message M3 for registration to the first registration module 114 and the second registration module 124 to notify the first cloud service platform 11 and the second cloud service platform 12 that the third temporary data storage module 133 currently stores the service program 100.

Preferably, the client device 14 further includes a roaming indexing module for recording the service program position messages used by the client device 14, so as to enable the client device 14 to rapidly communicate with the cloud service platform storing the service program 100 to obtain the service next time. When the first communication control processing module 112 stores the service program used by the client device 14 into the first temporary data storage module 113, the first communication control processing module 112 may further generate a first service program position message and transmit the first service program position message to the roaming indexing module of the client device 14 for recording. That is to say, the first service program position message M1, the second service program position message M2 or the third service program position message M3 may be stored in the roaming indexing module, so as to enable the client device 14 to immediately communicate with a cloud service platform storing the service program 100 without using a mutual registration procedure between the cloud service platforms. Thereby, the time required for searching the cloud service platform during wireless roaming can be reduced. Moreover, by using the roaming indexing module, the client device 14 can record personalized services and cloud service platforms having service programs demanded by the client device 14, so as to enable a cloud service platform adjacent to the client device 14 to directly obtain the service from remote cloud service platforms and provide corresponding cloud services to the client device 14.

Preferably, the client device 14 further includes a service migration module for assigning a cloud service platform that the service request message would be sent to, for example, the first cloud service platform 11, the second cloud service platform 12 or the third cloud service platform 13. So that, when a certain cloud service platform (for example, the first cloud service platform 11, the second cloud service platform 12 or the third cloud service platform 13) has an error or abnormal bandwidth rate, the client device 14 can assign other cloud service platforms which can service normally and that the service request message would be sent to, or in consideration of service quality or security in use of the cloud service, the client device 14 can use the service migration module to assign a cloud service platform with high service quality or reliability for using.

It can be seen that, the cloud service system of the present invention stores the service program corresponding to the cloud service used by the client device into the temporary data storage module and uses a registered notification mode to enable each cloud service platform to record the service program position message of the service program used by the client device 14, and learn about which cloud service platform the service program 100 used by the client device 14 is currently stored in, so as to enable the client device 14 at any place to use an adjacent cloud service platform to continue using the service program 100.

Therefore, no matter where the client device 14 is located, once the client device 14 in a roaming state is linked to the cloud service system through a wireless Internet, if the linked cloud service platform has the service program 100, the cloud service platform can immediately provide the service program 100 for use by the client device 14; and if the linked cloud service platform does not have the service program 100, the linked cloud service platform can obtain the service program 100 from another cloud service platform used by the client device 14 last time by using a link path provided by a service index of the linked cloud service platform.

Whereby, the following advantages are obtained. Since each cloud service platform uses the registered mutual notification mode, the entire cloud service system can optimize long routes, so that the response time till the client device obtains the service program is reduced, thereby improving the service efficiency; and since each cloud service platform does not need to deploy in advance all the service programs that the client device may use, resource waste is reduced. Meanwhile, no matter where the client device 14 is located, the progress of the service program 100 obtained by using the cloud service platform is continuous (for example, the service program 100 continues the progress of last use), so as to maintain the continuity of the service provided to the client device 14, thereby improving the overall service efficiency and quality of the cloud service system.

In addition, it can be seen from the above embodiment that, the first, second and third cloud service platforms of the cloud service system are merely for description, and in practical applications, the number of the cloud service platforms of the cloud service system is not thus limited (the number may be two or more), so as to provide better cloud services to the client device.

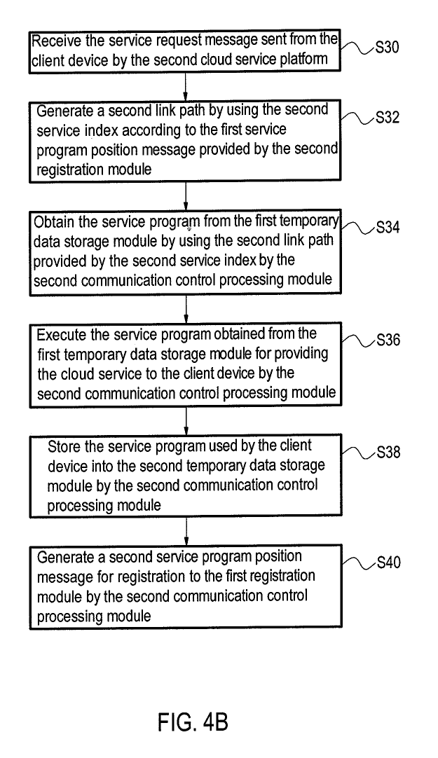

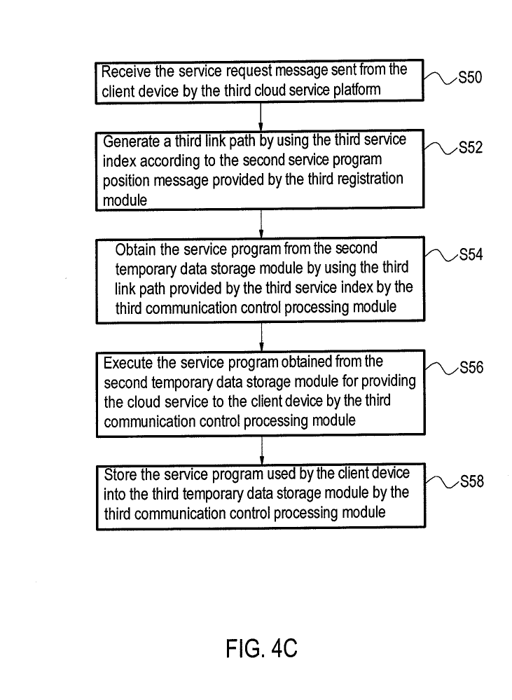

Referring to FIG. 3B to FIG. 3D and FIG. 4A, FIG. 4A is a flow chart of a cloud service method according to an embodiment of the present invention.

It can be seen from FIG. 4 A that, the cloud service method is applicable to a cloud service system, in which the cloud service method is described with reference to the cloud service system of FIG. 3B to FIG. 3D for sake of conciseness, but the present invention is not thus limited.

The cloud service method includes: providing at least one service program by the server (Step S10); receiving a service request message sent from a client device by the first cloud service platform (Step S12); determining whether the first temporary data storage module stores a service program corresponding to the service request message by the first communication control processing module (Step S14); if the first temporary data storage module does not store the service program, obtaining the service program from the server by using a first link path preset in the first service index by the first communication control processing module (Step S16); executing the service program obtained from the server for providing a cloud service to the client device by the first communication control processing module (Step S18); and storing the service program corresponding to the cloud service used by the client device into the first temporary data storage module by the first communication control processing module (Step S20).

In some embodiments, in the step of providing at least one service program by the server 10 (Step S10), the cloud service system may store a service program 100 in the server 10 in advance, so as to provide a cloud service to a client device, and the service program 100 includes software or operating system services. The server 10, the first cloud service platform 11, the second cloud service platform 12 and the third cloud service platform 13 are capable of communication with each other (for example, through a wired or wireless network). The first service index 111, the second service index 121 and the third service index 131 all include preset link paths of the service program 100 so as to learn about that the server 10 stores the service program 100.

In the step of receiving the service request message sent from the client device by the first cloud service platform (Step S12), as shown in FIG. 3B, when the client device 14 is located at the first place P1 and intends to obtain the service program 100, the cloud service system uses the first cloud service platform 11 to receive the service request message sent from the client device 14.

In the step of determining whether the first temporary data storage module stores the service program by the first communication control processing module (Step S14), the first communication control processing module 112 determines whether the first temporary data storage module 113 stores the service program 100 corresponding to the service request message sent from the client device 14.

In the step of if the first temporary data storage module does not store the service program, obtaining the service program from the server by using the first link path preset in the first service index by the first communication control processing module (Step S16), the first communication control processing module 112 obtains the service program 100 from the server 10 by using the first link path preset in the first service index 111.

In the step of executing the service program obtained from the server for providing the cloud service to the client device by the first communication control processing module (Step S18), after the first communication control processing module 112 obtains the service program 100 from the server 10, the first communication control processing module 112 executes the service program 100 obtained from the server 10 for providing the cloud service to the client device 14.

In the step of storing the service program corresponding to the cloud service used by the client device into the first temporary data storage module by the first communication control processing module (Step S20), after the client device 14 uses the service program 100 corresponding to the cloud service, the first communication control processing module 112 stores the service program 100 corresponding to the cloud service used by the client device into the first temporary data storage module 113, so as to maintain the progress of the use of the service program 100 corresponding to the cloud service of the client device 14 to facilitate continuous use next time, and the first communication control processing module 112 generates the first service program position message M1 for registration to the second registration module 124 and the third registration module 134 to notify the second cloud service platform 12 and the third cloud service platform 13 that the first temporary data storage module 113 currently stores the service program 100 corresponding to the cloud service used by the client device 14.

Further, the cloud service method may further include: if the first temporary data storage module stores the service program, executing the service program stored in the first temporary data storage module for directly providing the cloud service to the client device by the first communication control processing module (Step S22); and generating a first service program position message for registration to the second registration module by the first communication control processing module (Step S26).

In the step of if the first temporary data storage module stores the service program, executing the service program stored in the first temporary data storage module for directly providing the cloud service to the client device by the first communication control processing module (Step S22), if the client device 14 is still located at the first place P1 and intends to use the cloud service next time, since the first communication control processing module 112 has stored the service program 100 corresponding to the cloud service used by the client device 14 into the first temporary data storage module 113 last time, the first communication control processing module 112 determines that the first temporary data storage module 113 stores the service program 100, and accordingly the first communication control processing module 112 executes the service program 100 stored in the first temporary data storage module 113 for directly providing the cloud service to the client device 14.

In the step of generating the first service program position message for registration to the second registration module by the first communication control processing module (Step S26), the first communication control processing module 112 generates the first service program position message M1 for registration to the second registration module 124 and the third registration module 134 to notify the second cloud service platform 12 and the third cloud service platform 13 that the first temporary data storage module 113 currently stores the service program 100 corresponding to the cloud service used by the client device 14.

FIG. 4B is a flow chart of the cloud service method for obtaining a service through a second cloud service platform according to an embodiment of the present invention.

In some embodiments, the cloud service method further includes: receiving the service request message sent from the client device by the second cloud service platform (Step S30); generating a second link path by using the second service index according to the first service program position message provided by the second registration module (Step S32); obtaining the service program from the first temporary data storage module by using the second link path provided by the second service index by the second communication control processing module (Step S34); executing the service program obtained from the first temporary data storage module for providing the cloud service to the client device by the second communication control processing module (Step S36); storing the service program used by the client device into the second temporary data storage module by the second communication control processing module (Step S38); and generating a second service program position message for registration to the first registration module by the second communication control processing module (Step S40).

In the step of receiving the service request message sent from the client device by the second cloud service platform (Step S30), as shown in FIG. 3C, when the client device 14 is located at the second place P2 and intends to obtain the service program 100, the cloud service system uses the second cloud service platform 12 to receive the service request message sent from the client device 14.

In the step of generating the second link path by using the second service index according to the first service program position message provided by the second registration module (Step S32), the second service index 121 generates the second link path according to the first service program position message M1 of the second registration module 124.

In the step of obtaining the service program from the first temporary data storage module by using the second link path provided by the second service index by the second communication control processing module (Step S34), the second communication control processing module 122 obtains the service program 100 corresponding to the cloud service used by the client device 14 last time from the first temporary data storage module 113 by using the second link path provided by the second service index 121.

In the step of executing the service program obtained from the first temporary data storage module for providing the cloud service to the client device by the second communication control processing module (Step S36), the second communication control processing module 122 executes the service program 100 obtained from the first temporary data storage module 113 for directly providing the cloud service to the client device 14.

In the step of storing the service program used by the client device into the second temporary data storage module by the second communication control processing module (Step S38), after the client device 14 uses the service program 100 corresponding to the cloud service, the second communication control processing module 122 stores the service program 100 corresponding to the cloud service used by the client device 14 into the second temporary data storage module 123, so as to maintain the progress of the use of the service program 100 of the client device 14 to facilitate continuous use next time.

In the step of generating the second service program position message for registration to the first registration module by the second communication control processing module (Step S40), the second communication control processing module 122 generates the second service program position message M2 for registration to the first registration module 114 to notify the first cloud service platform 11 that the second temporary data storage module 123 currently stores the service program 100 used by the client device 14. Since the cloud service system of this embodiment includes the third cloud service platform 13, the second service program position message M2 generated by the second communication control processing module 122 is registered to the first registration module 114 and the third registration module 134 to notify the first cloud service platform 11 and the third cloud service platform 13 that the second temporary data storage module 123 currently stores the service program 100 used by the client device 14.

FIG. 4C is a flow chart of the cloud service method for obtaining a service through a third cloud service platform according to an embodiment of the present invention. The cloud service method further includes: receiving the service request message sent from the client device by the third cloud service platform (Step S50); generating a third link path by using the third service index according to the second service program position message provided by the third registration module (Step S52); obtaining the service program from the second temporary data storage module by using the third link path provided by the third service index by the third communication control processing module (Step S54); executing the service program obtained from the second temporary data storage module for providing the cloud service to the client device by the third communication control processing module (Step S56); and storing the service program used by the client device into the third temporary data storage module by the third communication control processing module (Step S58).

In the step of receiving the service request message sent from the client device by the third cloud service platform (Step S50), as shown in FIG. 3D, when the client device 14 is located at the third place P3 and intends to obtain the service program 100, the cloud service system uses the third cloud service platform 13 to receive the service request message sent from the client device 14.

In the step of generating a third link path by using the third service index according to the second service program position message provided by the third registration module (Step S52), the third service index 131 generates the third link path according to the second service program position message M2 of the third registration module 134.

In the step of obtaining the service program from the second temporary data storage module by using the third link path provided by the third service index by the third communication control processing module (Step S54), the third communication control processing module 132 obtains the service program 100 corresponding to the cloud service used by the client device 14 last time from the second temporary data storage module 123 by using the third link path provided by the third service index 131.

In the step of executing the service program obtained from the second temporary data storage module for providing the cloud service to the client device by the third communication control processing module (Step S56), the third communication control processing module 132 executes the service program 100 obtained from the second temporary data storage module 123 for directly providing the cloud service to the client device 14, so as to provide the cloud service dedicated to the client device 14.

In the step of storing the service program used by the client device into the third temporary data storage module by the third communication control processing module (Step S58), after the client device 14 uses the service program 100 corresponding to the cloud service, the third communication control processing module 132 stores the service program 100 corresponding to the cloud service used by the client device 14 into the third temporary data storage module 133, so as to maintain the progress of the use of the service program 100 of the client device 14 to facilitate continuous use next time.

Further, the third communication control processing module 132 generates the third service program position message M3 for registration to the first registration module 114 and the second registration module 124 to notify the first cloud service platform 11 and the second cloud service platform 12 that the third temporary data storage module 133 currently stores the service program 100 used by the client device 14.

In addition, the cloud service method may also be applied to a computer readable recording medium. The recording medium stores a computer program, and is applicable to the cloud service system. When the computer program is executed by the cloud service system (for example, the computer program is executed by a computer host device of the cloud service system), the cloud service method is completed. For the cloud service system and the cloud service method, reference is made to FIG. 3A to FIG. 4C and the descriptions thereof for sake of conciseness, and the details will not be described herein again.

Based on the above, the cloud service system, method and recording medium of the present invention have the following advantages:

1. Since the service program corresponding to the cloud service used by the client device is stored in the temporary data storage module, and each cloud service platform uses the registered mutual notification mode, the entire cloud service system can optimize long routes, so that the response time till the client device obtains the service program is reduced, thereby improving the service efficiency.

2. Since the client device uses the same service program, that is, does not need to repeatedly deploy the service program, resource waste is reduced.

3. No matter where the client device is located, the client device at any place can use an adjacent cloud service platform to continue using the service program, so that the progress of the service program corresponding to the cloud service is continuous, so as to maintain the continuity of the cloud service provided to the client device, thereby improving the overall service efficiency and quality of the cloud service system.

4. The client device further includes the roaming indexing module for recording the first service program position message, the second service program position message or the third service program position message, so as to enable the client device to immediately communicate with a cloud service platform storing the service program without using a mutual registration procedure between the cloud service platforms, thereby reducing the time required for searching the cloud service platform during wireless roaming; or by using the roaming indexing module, the client device can record personalized services and cloud service platforms having service programs demanded by the client device, so as to enable a cloud service platform adjacent to the client device to directly obtain the service programs from remote cloud service platforms and provide corresponding cloud services to the client device.

5. The client device further includes the service migration module for assigning the first cloud service platform, the second cloud service platform or the third cloud service platform that the service request message would be sent to, so that when a certain cloud service platform (for example, the first cloud service platform, the second cloud service platform or the third cloud service platform) has an error or abnormal bandwidth rate, the client device can assign a cloud service platform which can service normally and that the service request message would be sent to, so as to use the service program in the cloud service platform with normal service quality, or in consideration of security in use of the cloud service, the client device can use the service migration module to assign a cloud service platform with high reliability for using.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A cloud service system, comprising:
a server, storing at least one service program; and
at least one cloud service platform, wherein the at least one cloud service platform comprises a first cloud service platform in communication with the server, and the first cloud service platform comprises a first service index, a first communication control processing module and a first temporary data storage module;
wherein when a client device sends a service request message to the first cloud service platform, the first communication control processing module determines whether the first temporary data storage module stores a service program corresponding to the service request message, and if the first temporary data storage module does not store the service program, the first communication control processing module obtains the service program from the server by using a first link path preset in the first service index, executes the service program obtained from the server for providing a cloud service to the client device, and stores the service program corresponding to the cloud service used by the client device into the first temporary data storage module.

2. The cloud service system according to claim 1, wherein when the client device sends the service request message to the first cloud service platform, if the first temporary data storage module stores the service program, the first communication control processing module executes the service program stored in the first temporary data storage module for directly providing the cloud service to the client device.

3. The cloud service system according to claim 1, further comprising a second cloud service platform in communication with the first cloud service platform, wherein the second cloud service platform comprises a second service index, a second communication control processing module, a second temporary data storage module and a second registration module, and when the first communication control processing module stores the service program corresponding to the cloud service used by the client device into the first temporary data storage module, the first communication control processing module further generates a first service program position message for registration to the second registration module.

4. The cloud service system according to claim 3, wherein when the client device sends the service request message to the second cloud service platform, the second service index generates a second link path according to the first service program position message of the second registration module, and the second communication control processing module obtains the service program from the first temporary data storage module by using the second link path provided by the second service index, executes the service program obtained from the first temporary data storage module for providing the cloud service to the client device, stores the service program used by the client device into the second temporary data storage module, and generates a second service program position message for registration to a first registration module of the first cloud service platform.

5. The cloud service system according to claim 4, further comprising a third cloud service platform in communication with the first cloud service platform and the second cloud service platform, wherein the third cloud service platform comprises a third service index, a third communication control processing module, a third temporary data storage module and a third registration module, and the second communication control processing module further generates the second service program position message for registration to the third registration module.

6. The cloud service system according to claim 1, wherein the client device is a mobile phone linked to the at least one cloud service platform through a telecommunication network, and the first cloud service platform is a cloud service platform adjacent to the client device among the at least one cloud service platform.

7. The cloud service system according to claim 1, wherein when the first communication control processing module stores the service program corresponding to the cloud service used by the client device into the first temporary data storage module, the first communication control processing module further generates a first service program position message for transmission to and recording by a roaming indexing module of the client device.

8. The cloud service system according to claim 1, wherein the client device further comprises a service migration module for assigning the first cloud service platform that the service request message would be sent to.

9. A cloud service method, applicable to a cloud service system comprising a server and at least one cloud service platform, wherein the at least one cloud service platform comprises a first cloud service platform, and the first cloud service platform is in communication with the server and comprises a first service index, a first communication control processing module and a first temporary data storage module, the cloud service method comprising:
providing at least one service program by the server;
receiving a service request message sent from a client device by the first cloud service platform;
determining whether the first temporary data storage module stores a service program corresponding to the service request message by the first communication control processing module;
if the first temporary data storage module does not store the service program, obtaining the service program from the server by using a first link path preset in the first service index by the first communication control processing module;
executing the service program obtained from the server for providing a cloud service to the client device by the first communication control processing module; and
storing the service program corresponding to the cloud service used by the client device into the first temporary data storage module by the first communication control processing module.

10. The cloud service method according to claim 9, further comprising:
if the first temporary data storage module stores the service program, executing the service program stored in the first temporary data storage module for directly providing the cloud service to the client device by the first communication control processing module.

11. The cloud service method according to claim 9, wherein the cloud service system further comprises a second cloud service platform in communication with the first cloud service platform, the second cloud service platform comprises a second service index, a second communication control processing module, a second temporary data storage module and a second registration module, and the step of storing the service program corresponding to the cloud service used by the client device into the first temporary data storage module by the first communication control processing module comprises:
generating a first service program position message for registration to the second registration module by the first communication control processing module.

12. The cloud service method according to claim 11, further comprising:
receiving the service request message sent from the client device by the second cloud service platform;
generating a second link path by using the second service index according to the first service program position message provided by the second registration module;
obtaining the service program from the first temporary data storage module by using the second link path provided by the second service index by the second communication control processing module;
executing the service program obtained from the first temporary data storage module for providing the cloud service to the client device by the second communication control processing module;
storing the service program used by the client device into the second temporary data storage module by the second communication control processing module; and
generating a second service program position message for registration to a first registration module of the first cloud service platform by the second communication control processing module.

13. The cloud service method according to claim 12, wherein the cloud service system further comprises a third cloud service platform in communication with the first cloud service platform and the second cloud service platform, and the third cloud service platform comprises a third service index, a third communication control processing module, a third temporary data storage module and a third registration module, the cloud service method further comprising:
generating the second service program position message for registration to the third registration module by the second communication control processing module.

14. The cloud service method according to claim 9, wherein the client device is a mobile phone linked to the at least one cloud service platform through a telecommunication network, and the first cloud service platform is a cloud service platform adjacent to the client device among the at least one cloud service platform.

15. A computer readable recording medium, for storing a computer program, and applicable to a cloud service system comprising a server and at least one cloud service platform, wherein the at least one cloud service platform comprises a first cloud service platform, the first cloud service platform is in communication with the server and comprises a first service index, a first communication control processing module and a first temporary data storage module, and when the computer program is executed by the cloud service system, a cloud service method is completed, the cloud service method comprising:
providing at least one service program by the server;
receiving a service request message sent from a client device by the first cloud service platform;
determining whether the first temporary data storage module stores a service program corresponding to the service request message by the first communication control processing module;
if the first temporary data storage module does not store the service program, obtaining the service program from the server by using a first link path preset in the first service index by the first communication control processing module;
executing the service program obtained from the server for providing a cloud service to the client device by the first communication control processing module; and
storing the service program corresponding to the cloud service used by the client device into the first temporary data storage module by the first communication control processing module.
